(19) United States
(12) Patent Application Publication
(10) Pub. No.: US 2016/0153507 A1
(43) Pub. Date: Jun. 2, 2016

(54) ELECTROMAGNETIC CLUTCH

(71) Applicant: DENSO CORPORATION, Kaniya=city, Aichi-pref (JP)

(72) Inventors: Kunihiro KADO, Kariya-city (JP); Kazunori MIZUTORI, Kariya-city (JP); Yasuo TABUCHI, Kariya-city (JP)

(21) Appl. No.: 14/900,565

(22) PCT Filed: May 28, 2014
(86) PCT No.: PCT/JP2014/002815

§ 371 Date: Dec. 21, 2015

(30) Foreign Application Priority Data
Jun. 26, 2013 (JP) 2013-134025

(51) Int. Cl. F16D 27/112; F16H 55/36

(52) U.S. Cl. CPC F16D 27/112; F16H 55/36; F16D 2027/008

(57) ABSTRACT

An electromagnetic clutch has an inner ring portion which is formed in a cylindrical shape and holds a bearing on an inner surface thereof, and a friction portion which has a friction surface extending in the radial direction from the inner ring portion. The electromagnetic clutch has an outer ring portion which is arranged around the inner ring portion, and is formed in a cylindrical shape, and is joined to the friction portion. A joined portion which joins the outer ring portion and the friction portion is disposed between the outer ring portion and the friction portion. The joined portion is formed by the friction welding process.

### CROSS REFERENCE TO RELATED APPLICATION

This application is based on Japanese Patent Application No. 2013-134025 filed on Jun. 26, 2013, the disclosure of which is incorporated herein by reference.

### TECHNICAL FIELD

A disclosed invention relates to an electromagnetic clutch which has an armature which is attracted to a friction portion by electromagnetic force generated by supplying electric current to an electromagnetic coil.

### BACKGROUND

Conventionally, an electromagnetic clutch in Patent Literature 1 is known. The electromagnetic clutch of Patent Literature 1 has a configuration shown in FIG. 19 later explained as a comparative example. The electromagnetic clutch has a magnetic metal plate formed in a disc shape with a pierced center portion. The magnetic metal plate forms a cylindrical inner ring portion 5 which projects from the center portion thereof. On a front surface thereof, the magnetic metal plate forms a friction portion 7 which forms a clutch portion.

A plurality of arcuate holes 16a and 16b are pierced on a part of friction portion 7. A pulley part 3 provided by a multiple V groove is formed on the outermost periphery of the magnetic metal plate by a rolling process. An outer ring portion 8 provided by a cylindrical shaped magnetic annular member is combined with the friction portion 7 to extend over from outside of the inner ring portion 5. This combination is provided by a plastically joining method.

The cylindrical outer ring portion 8 is press-fit and fixed to a ring shaped stepped portion 30 formed on the friction portion 7. Before press-fit it, a plurality of lines of the grooves 31, such as a V-shaped, are formed near the press-fit side end which faces the stepped portion 30 of the outer ring portion 8. The plurality of lines of the grooves 31 of the outer ring portion 8 are press-fitted into an inside of the stepped portion 30. At this time, an outside of the stepped portion 30 is pressurized and is plastically deformed into a radial inside of the stepped portion 30 by an annular shaped die. Thereby, the outer ring portion 8 and the friction portion 7 with the stepped portion 30 are plastically combined by making the stepped portion 30 to flow into the plurality of lines of the grooves 31.

### CITATION LIST

### Patent Literatures

Patent Literature 1: JPS63-297827A

### SUMMARY

However, the following problems exist among the electromagnetic clutches which adopted the plastically combining method. In methods such as a press-fit and the plastically combining method, both members combined each other are merely combined in a mechanical manner. There is comparatively large magnetic resistance between both members. Therefore, there may be a lowering of performance of the electromagnetic clutch.

A way of increasing a contact-surface area of an integrally formed member having the cylindrical outer ring portion 8 and the friction portion 7 may be considered as a solution to improve performance of the electromagnetic clutch. However, this way may also increase a weight. In addition, since the outer ring portion 8 needs a rigidity to withstand press fitting, a weight increase is not avoidable. Further, if members made of different material are used for the outer ring portion 8 and the integrally formed member having the friction portion 7, it is necessary to take into consideration a difference of a coefficient of linear expansion, and the freedom of member selection is restricted. That is, it is necessary to take into consideration a lowering of strength resulting from a linear expansion of a part which is plastically combined.

Further, regarding a manufacturing method for an electromagnetic clutch, there may be a problem of increasing of difficulties in manufacturing process, since it is necessary to increase weight for keeping a press-fit margin extending in the right-and-left direction in FIG. 19, and to manage the press-fit margin. For example, restricting in a plastically combining process, it is necessary to perform the following three steps: forming a plurality of lines of grooves 31 such as in V-shaped on the outer ring portion; press-fitting the outer ring portion 8 in the stepped portion 30 of a clutch portion, and plastically deforming a part of the integrally formed member having the friction portion 7 by pressing it by an annular shaped die.

In view of the above-mentioned problem, it is an object to of the invention disclosed here to provide an electromagnetic clutch which can improve performance of the electromagnetic clutch with less magnetic resistance on a magnetic circuit, and which can suppress weight increase, and which has less restriction on the freedom of material selection related to the difference of coefficients of linear expansion which is took into consideration.

The content of Patent Literatures listed as prior art may be used and incorporated by reference as description for technical components disclosed in this description.

The disclosed invention employs the following technical means, in order to attain the above-mentioned object. One invention disclosed is an electromagnetic clutch for transmitting rotational force from a one side member to the other side member by using electromagnetic force, which comprises an inner ring portion (5) which is formed in a cylindrical shape and holds a bearing (4) on an inner surface thereof, and a friction portion (7) which has a friction surface (6) extending in a radial direction from the inner ring portion (5). The electromagnetic clutch comprises an outer ring portion (8) which is formed in a cylindrical shape, arranged to cover an outer periphery of the inner ring portion (5), and is joined to the friction portion (7), and a pulley portion (3) which provides the one side member and is formed integrally with the friction portion (7) or the outer ring portion (8). The electromagnetic clutch comprises a stator (11, 12, 15) including an electromagnetic coil (12) arranged between an outer surface of the inner ring portion (5), and an inner surface of the outer ring portion (8), and an armature (13) which provides the other side member and is attracted to the friction portion (7) by the electromagnetic force generated by the electromagnetic coil (12). In addition, the outer ring portion (8) is joined to the friction portion (7) by a joined portion (9) formed by a friction welding process.

According to this invention, since the outer ring portion (8) is joined by the joined portion (9) formed in the friction portion (7) by the friction welding process, the outer ring portion (8) and the friction portion (7) join together firmly with metal all over the joined portion (9). Accordingly, it is possible to achieve a magnetic property that is similar to a case of integrally forming the outer ring portion (8) and the friction portion (7). That is, magnetic flux generated by the electromagnetic coil (12) flows into the friction portion (7) from the outer ring portion (8) in a less magnetic resistance condition. Thereby, it can increase an attracting force by a small configuration, and can improve performance of the electromagnetic clutch 1. And a weight increment can be suppressed. In addition, since the joined portion (9) joins firmly with metal, it has less restriction on the freedom of material selection related to the difference of coefficients of linear expansion which is took into consideration.

The symbols and explanation in the parenthesis raised in the claim and the above section are examples to show correspondence relations with concrete elements described in later mentioned embodiments in an easy to understand way, and are not intended to limit the content of the invention.

### BRIEF DESCRIPTION OF THE DRAWINGS

FIG. 1 is a vertical cross sectional view of an electromagnetic clutch according to a first embodiment of the invention;

FIG. 2 is a vertical cross sectional view of a rotor of the electromagnetic clutch of the embodiment;

FIG. 3 is a side view of the rotor seen from the arrow symbol III in FIG. 2;

FIG. 4 is a process explanatory view showing a configuration before rolling of the magnetic metal plate in the embodiment;

FIG. 5 is a process explanatory view showing a cross sectional shape of the magnetic metal plate after rolling in the embodiment;

FIG. 6 is a process explanatory view showing a condition formed a pulley portion in the embodiment;

FIG. 7 is a process explanatory view showing the outer ring portion in a cylindrical shape in the embodiment;

FIG. 8 is a process explanatory view showing the rotor after a friction welding in the embodiment;

FIG. 9 is a friction welding explanatory view illustrating a condition in which a relative rotation difference is generated by pressing the outer ring portion on the friction portion in the embodiment;

FIG. 10 is a friction welding explanatory view illustrating a condition in which frictional heat is generated on contacting surfaces in the embodiment;

FIG. 11 is a friction welding explanatory view illustrating a condition in which burr are created by applying thrust after stopping rotation at the friction welding in the embodiment;

FIG. 12 is a vertical cross sectional view of a rotor according to a second embodiment of the invention;

FIG. 13 is a vertical cross sectional view of a part of a rotor according to a third embodiment of the invention;

FIG. 14 is a perspective view of a metal ring which forms an outer ring portion for an electromagnetic clutch according to a fourth embodiment of the invention;

FIG. 15 is a side view of a rotor of the electromagnetic clutch of the fourth embodiment;

FIG. 16 is a partial vertical cross sectional view of an electromagnetic clutch according to a fifth embodiment of the invention;

FIG. 17 is a partial vertical cross sectional view of an electromagnetic clutch according to a seventh embodiment of the invention;

FIG. 18 is a partial vertical cross sectional view of a rotor according to the seventh embodiment of the invention; and

FIG. 19 is a vertical cross sectional view of a rotor of a comparative example.

### DETAILED DESCRIPTION

Embodiments of the present disclosure are explained referring to drawings. In the embodiments, the parts corresponding to the matter described in the previous embodiment are indicated with the same reference numbers and the same descriptions will not be reiterated. In a case that only a part of component is described, the other embodiments previously described may be applied to the other parts of components.

It is possible to combine the embodiments in some forms which are clearly specified in the following description, and also, unless trouble arises, in some forms which are not clearly specified.

### First Embodiment

This first embodiment provides an inner ring portion for holding a bearing, a friction portion which has a friction surface with an armature, and a pulley portion on which a belt is engaged by an integrally formed member. This integrally formed member is formed by rolling process. An outer ring portion for configuring a magnetic circuit is attached to the integrally formed member by a friction welding process. Since the metal members are firmly joined at all over a joined portion by carrying out the friction welding process, a magnetic property equivalent to a case of integral formed is acquired. Hereafter, detailed description is provided while referring to the drawings.

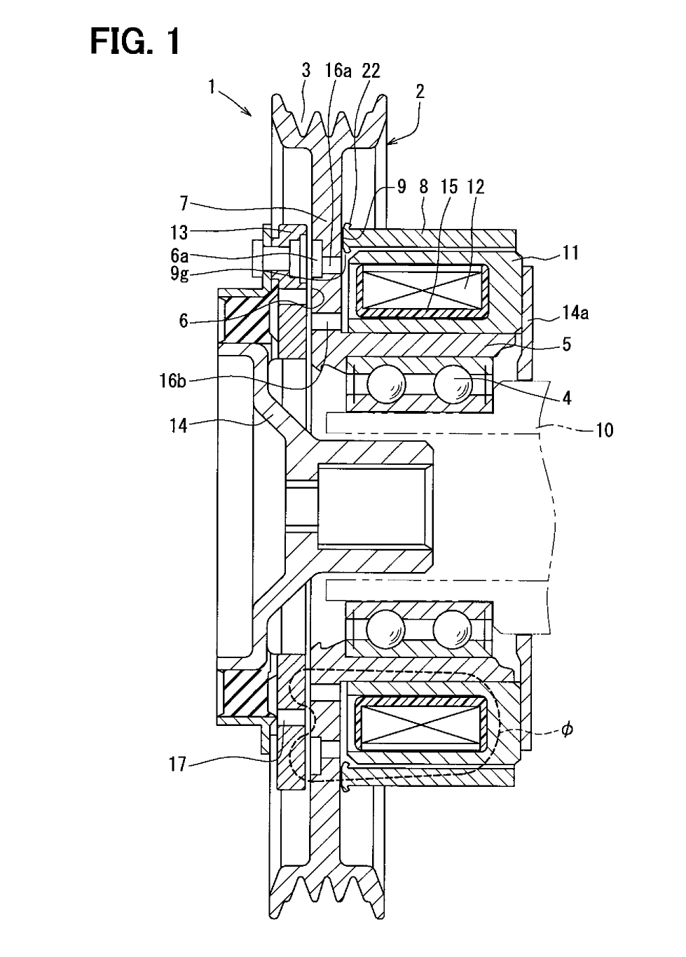

FIG. 1 shows an electromagnetic clutch according to the first embodiment of the invention. This electromagnetic clutch 1 is an apparatus for driving a compressor, not illustrated, for compressing a refrigerant of a vehicle air-conditioner. Specifically, by turning on and turning off the electromagnetic clutch 1, engine power is transmitted to or not transmitted to the compressor. The rotor 2 of this electromagnetic clutch 1 has a pulley portion 3 which may differ in outside diameter or arrangement according to kinds of vehicles on which the electromagnetic clutch 1 is mounted.

The electromagnetic clutch 1 has an inner ring portion 5 for holding a bearing 4, and a friction portion 7 which has a friction surface 6. The inner ring portion 5, the friction portion 7, and the pulley portion 3 where a belt is applied are made by the integrally formed member. The integrally formed member is indicated by reference symbols 5 and 7 in the following description. An outer ring portion 8 for configuring a magnetic circuit is combined to the integrally formed member 5 and 7 by the friction welding process. The outer ring portion 8 and the friction portion 7 are combined by this friction welding process through a joined portion 9. In addition, in order to avoid collision of burr 22 formed by the friction welding process with an electromagnetic coil 12, for accommodating the burr 22, a clearance 9g extending in an axial direction is formed on a part of an outer corner of the electromagnetic coil 12 next to the burr 22.

The friction welding process itself is a well-known technique, and some processing apparatus for the friction welding process are available in the market. The friction welding process is also called friction bonding, friction stir joining, or friction welding. The friction welding process is a method which joins metal members by using frictional heat energy generated by contacting and rotating them effectively and applying high pressure.

By forming the joined portion 9 using the friction welding process, since the metal members are firmly joined all over the joined portion 9, it is possible to achieve a magnetic property and strength that are similar to a case of using an integrally formed member with continuous material.

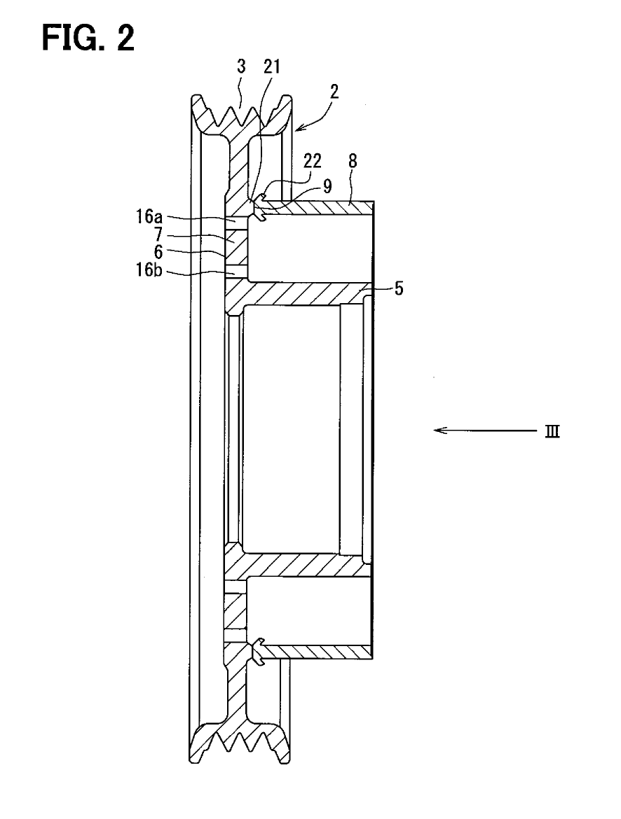

The electromagnetic clutch 1 shown in FIG. 1 receives revolution power generated by an engine on the pulley portion 3, and connects or disconnects transmitting function to an armature 13 and a rotatable hub 14 which are connected with a compressor for compressing refrigerant in a refrigeration cycle. FIG. 2 shows a configuration of a rotor 2 of the electromagnetic clutch in FIG. 1.

In FIGS. 1 and 2, the electromagnetic clutch 1 has a stator 11 which will be fixed to a housing 10 of the compressor shown by an alternate dashed line, and an electromagnetic coil 12 accommodated in the stator 11. The electromagnetic clutch 1 has the armature 13 which is attracted to the friction surface 6 of the friction portion 7 by the magnetic force generated by the electromagnetic coil 12 turned in a ring shape, and the rotatable hub 14 which transmits the revolution power on the armature 13 to an input shaft of the compressor.

The stator 11 is an annular member made of magnetic metal which accommodates the ring shaped electromagnetic coil 12, and is fixed to the housing 10 of the compressor through a disc shaped stay 14a. The electromagnetic coil 12 is a member formed by a magnet coil wound on an outside of a resin made bobbin 15, and is mounted within the stator 11, and is fixed within the stator 11 by an adhesive bond etc.

As shown in FIG. 2, the rotor 2 has the inner ring portion 5, the friction portion 7, the pulley portion 3, and the outer ring portion 8. The rotor 2 is made of magnetic metal, e.g., is made of steel containing small amount of carbon. The rotor 2 has an annular portion having a U-shaped cross-section which is open toward an opposite side to the armature 13 to accommodate the stator 11 in FIG. 1. The rotor 2 is supported in a rotatable manner by the housing 10 of the compressor through the bearing 4 attached to the inner surface. An inner surface of the bearing 4 is supported by the housing 10 of the compressor shown by the alternate dashed line.

The rotor 2 is formed by rolling magnetic metal material, such as a soft iron. It has the inner ring portion 5 forming an inner wall positioned on an inside of the electromagnetic coil 12, and the outer ring portion 8 forming an outer wall positioned on an outside of the electromagnetic coil 12. The rotor 2 has the friction portion 7 having the friction surface 6 which is also called a friction wall, and performs a friction engagement with the armature 13.

The inner surface of the inner ring portion 5 is processed by cutting process to be attached with the bearing 4. The pulley portion 3 is processed by pressing process from an outer surface toward an inner surface, and is formed with a plurality of belt grooves on which a multi-type V-belt not shown is applied.

The friction portion 7 forms a ring shaped projection of the magnetic member. The friction portion 7 has magnetic cutoff portions 16a and 16b, which are generically called a magnetic cutoff portion 16, provided by an arcuate hole or a slit penetrating from the front side to the rear side of the side surface. The magnetic cutoff portion 16 adjusts magnetic flux flow generated by the electromagnetic coil 12.

Regarding the magnetic cutoff portion 16, although it is known that nonmagnetic metal material, such as copper, may form it, the arcuate hole or the slit forms it in this embodiment. The magnetic cutoff portion 16 is a portion which prevents from forming a shortcut magnetic path which passes the magnetic flux φ (phi) entered the armature 13 from the inner ring portion 5 directly through an inside of the armature 13. By function of the magnetic cutoff portion 16, the magnetic flux φ (phi) flows as illustrated with the broken line in the lower part of FIG. 1, and the armature 13 is attracted towards the friction surface 6.

A friction material 6a made of nonmagnetic material which increases an engaging force with the armature 13 is inserted on the friction surface 6 of the friction portion 7 on a left side surface in FIG. 1. The armature 13 is arranged to face the friction surface 6 via a gap. The armature 13 is supported movable in the axial direction, and is able to be engaged with the friction surface 6.

The armature 13 is formed to show a ring shape made of magnetic material, such as iron, and is formed with a slit 17 which functions as a magnetic cutoff portion on an intermediate part. The rotatable hub 14 is a member which rotates together with the armature 13 by receiving revolution of the armature 13 and drives the input shaft of the compressor, and is fixed to the armature 13.

The magnetic flux φ (phi) shown in the lower part of FIG. 1 by a broken line is generated in a W shape over the rotor 2 and the armature 13, when exciting current flows through the electromagnetic coil 12. When the electromagnetic coil 12 is excited, as well known in the field, the armature 13 is pushed against the friction surface 6 to shorten the magnetic path length of the above-mentioned magnetic flux φ (phi). The armature 13 and the friction surface 6 are engaged by friction, and the armature 13 rotates with the rotor 2. As a result, the revolution power of the engine transmitted to the rotor 2 through the V-belt is transmitted to the input shaft of the compressor through the armature 13 and the rotatable hub 14.

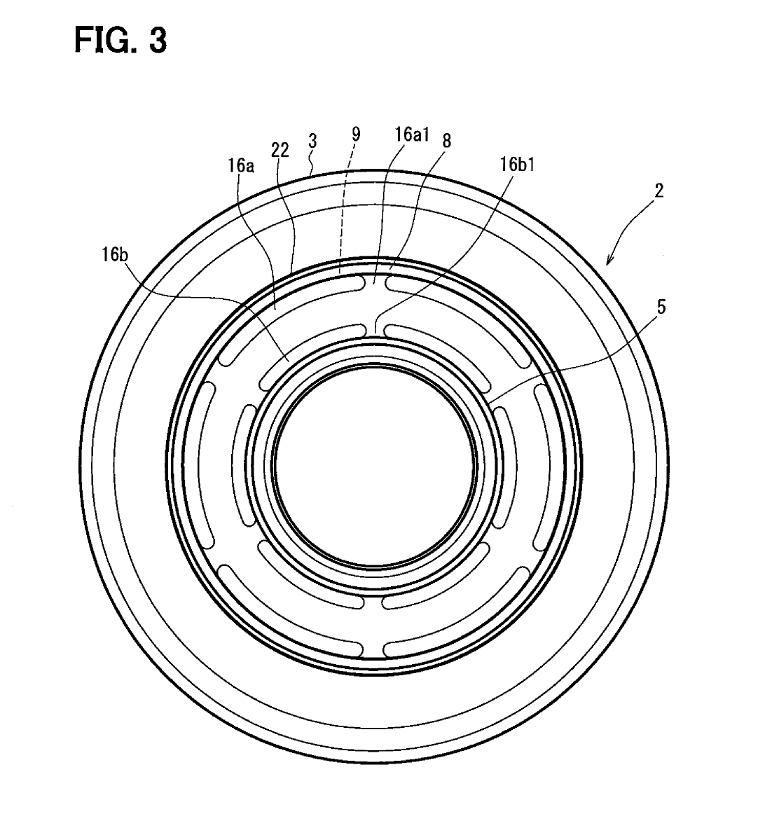

FIG. 3 shows a side of the rotor viewing from the arrow symbol III in FIG. 2. The inner ring portion 5 and the outer ring portion 8 are arranged in a concentric manner. The inner ring portion 5 and the outer ring portion 8 are connected through bridge parts 16a1 between the magnetic cutoff portions 16a on a radial outside, and bridge parts 16b1 between the magnetic cutoff portions 16b on a radial inside.

Manufacturing Method

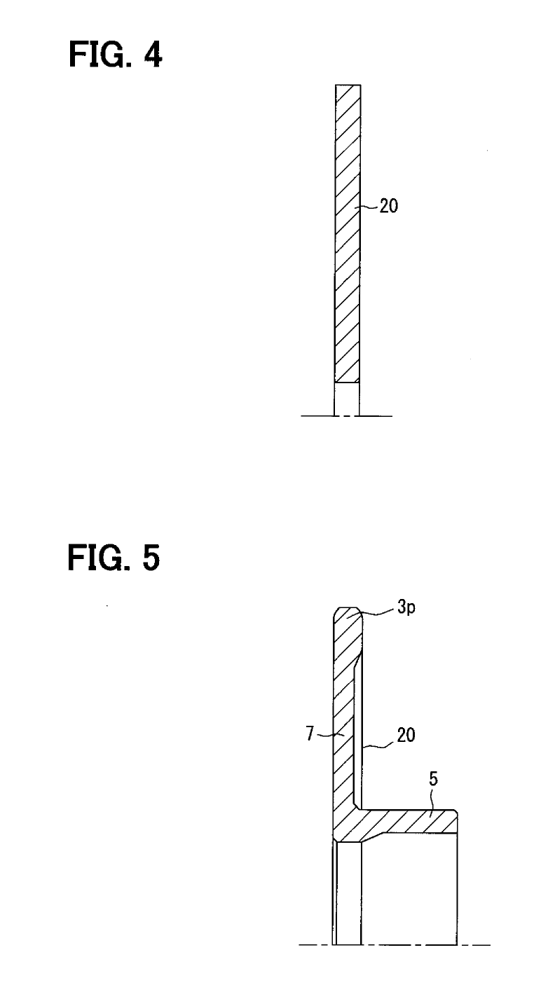

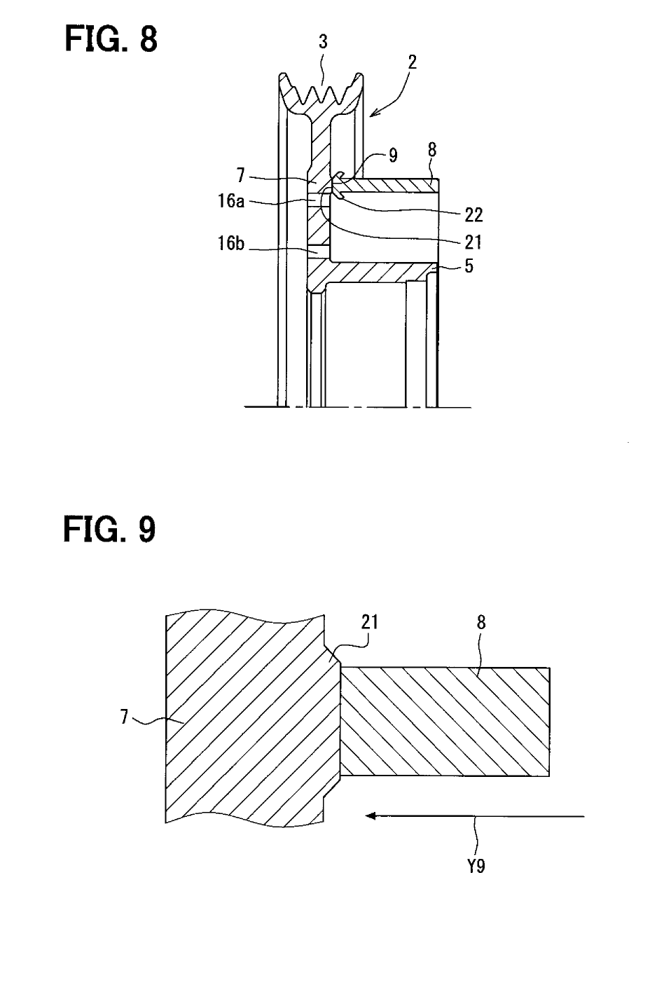

Next, a manufacturing method of the electromagnetic clutch 1, especially the rotor 2 is explained. FIG. 4 or 8 are process explanatory views in the case of manufacturing the rotor in the first embodiment. FIG. 4 shows a cross sectional shape of the magnetic metal plate 20 before a rolling process. First, the magnetic metal plate 20 of a disc shape with a pierced center is prepared.

FIG. 5 shows a cross sectional shape of the magnetic metal plate 20 after a rolling process. The integrally formed member 5 and 7, which is formed in a ring shape, and has a L-shaped cross section, and has the inner ring portion 5, the friction portion 7, and a part 3p to be the pulley portion, is formed. Here, the integrally formed member 5 and 7 is formed by a rolling process which is a plastically deforming process method which forms a desired shape by applying a strong force to a metal material and making metal material flow. In a procedure of the rolling process, a material is clamped by rolling dies, and the dies are pressurized in a direction to a center of the material while rotating the material. By applying the pressure beyond the yield point of the material, the material is plastically deformed and is deformed permanently.

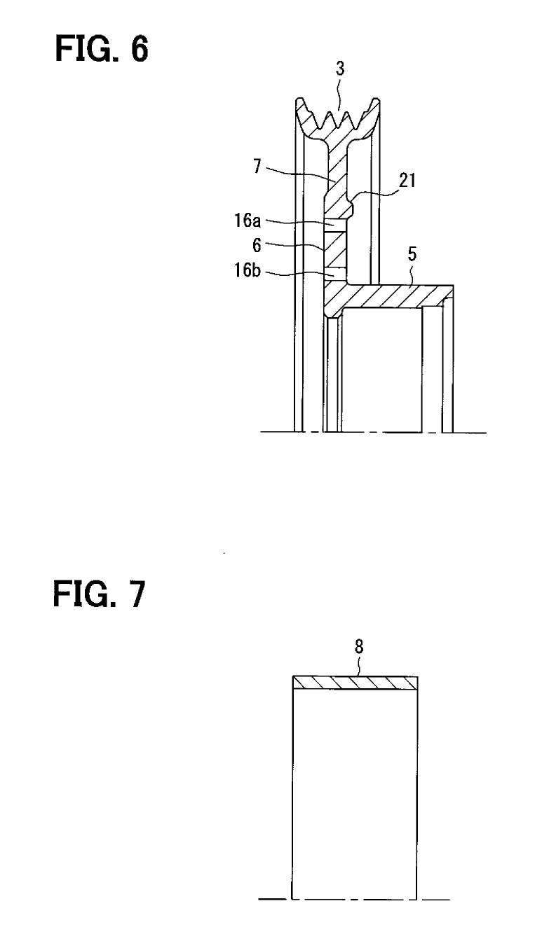

FIG. 6 shows a condition where the pulley portion 3 is formed. The pulley portion 3 provided by a multiple V groove is formed on the part 3p to be the pulley portion in FIG. 5 by the rolling process as shown in FIG. 6. Then, the magnetic cutoff portions 16a and 16b which are formed by the arcuate hole or the slit are formed by a piercing process.

Then, as shown in FIG. 7, the outer ring portion 8 of a cylindrical shape is prepared. FIG. 7 shows a cross section of the upper half of the outer ring portion 8 of a cylindrical shape. The magnetic annular member shown in FIG. 7 is placed as the outer ring portion 8, and is pressurized onto the friction portion 7 of the integrally formed member 5 and 7 from the axial direction and the outer ring portion 8 is rotated. The rotation of the outer ring portion 8 is applied by the friction welding machine about a center which is a center axis of the outer ring portion 8 while gripping the outside of the outer ring portion 8.

By the friction welding process, the left side end of the outer ring portion 8 and a wall of the friction portion 7 are firmly combined via metal each other, and becomes condition shown in FIG. 8. For a period of the friction welding process, in order to improve a heat balance of the integrally formed member 5 and 7 of the rotor 2 and the magnetic annular member to be the outer ring portion 8, a projection 21 may be formed on a portion where a joined portion is formed on the friction portion 7. The projection 21 is shown in FIG. 6 and is formed by a die pressing process and is in about 1 mm height. The projection 21 makes the quality of the joined portion 9 being stabilized more.

In FIG. 2, FIG. 6, and FIGS. 8-11, the projection 21 is illustrated in an emphasizing manner to help understanding. In a completed state of the friction welding process in FIG. 1, the projection is hardly visible. In FIG. 8, frictional heat is generated by creating rotational difference between the friction portion 7 and the outer ring portion 8 by fixing a side of the friction portion 7 in which the pulley portion 3 exists and by rotating the outer ring portion 8.

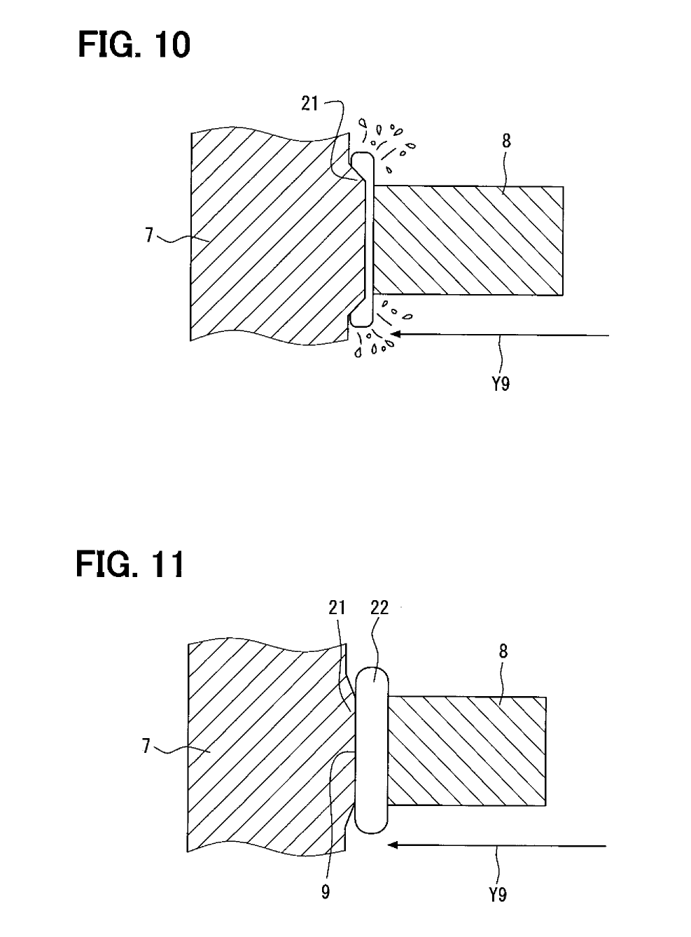

Next, process of the friction welding process is explained by using FIGS. 9-10. FIG. 9 illustrates a condition where the outer ring portion 8 is pressed onto the friction portion 7, and rotational difference occurred relatively. A projection 21 formed by a pressing process having about 1 mm height is formed on a portion of the friction portion 7 which becomes the joined portion. After setting the friction portion 7 and the outer ring portion 8 on a predetermined position, the outer ring portion 8 is fixed, and the friction portion 7 is rotated and moved forward in a direction of the arrow symbol Y9.

FIG. 10 illustrates a condition where frictional heat is generated on the contacting surface on which two members to be joined by the friction welding process are contacted. When frictional heat is generated and it reaches to a temperature suitable for joining, the rotation of the outer ring portion 8 is stopped by suddenly stepping the rotation of a main shaft of the friction welding machine not illustrated.

FIG. 11 illustrates a condition where the burr 22 in a curled shape is formed by applying an up-set-thrust force for a predetermined time after the rotation is stopped. Although the projection 21 formed by the pressing process is formed on the portion to be the joined portion 9, the process may be performed so that the projection 21 disappears substantially, or the projection 21 remains. In a case of the projection 21 remains, the burr 22 in a curled shape may be formed on a side of the friction portion 7 too.

In this embodiment, a manufacturing method of the electromagnetic clutch 1 which attracts the armature 13 towards the friction portion 7 made of the magnetic metal by the electromagnetic force generated by the electromagnetic coil 12 is provided. This manufacturing method includes a process of forming the cylindrical outer ring portion 8 made of the magnetic metal which is arranged next to the electromagnetic coil 12 in order to provide the magnetic path which allows passing the magnetic flux generated by the electromagnetic coil 12. This manufacturing method includes a process of joining the outer ring portion 8 and the friction portion 7 by the friction welding process by contacting the outer ring portion 8 onto the friction portion 7, and by relatively moving them while pushing them each other. The friction welding process is performed so that the material forming the outer ring portion 8 and the material forming the friction portion 7 may be melted and form an integral joined portion 9.

The friction welding process is performed so that melted material produced between the outer ring portion 8 and the friction portion 7 extends in a radial inside and/or in a radial outside and forms the burr 22. The friction welding process is performed by rotating relatively the outer ring portion 8 and the friction portion 7 about an axis of the outer ring portion 8 while pressing the outer ring portion 8 and the friction portion 7 each other along the axial direction of the outer ring portion 8. In the friction welding process, the outer ring portion 8 is pushed onto the top of the annular projection 21 which is formed on the friction portion 7 previously. After the friction welding process, there is a process of cooling and hardening the melted material produced between the outer ring portion 8 and the friction portion 7.

Processing of the friction welding process is performed so that the burr 22 becomes a size which does not contact the stator 11, 12, and 15 including the electromagnetic coil 12. The outer ring portion 8 and the friction portion 7 are formed by a surface treated iron plate having a surface treated layer which is destroyed during processing of the friction welding process. Before a processing of the friction welding process, the process may have a processing for forming an annular depression for forming a clearance 9g for accommodating the burr 22 on the friction portion 7, the outer ring portion 8, or the stator.

According to the above-mentioned manufacturing process, the following functions and advantages are demonstrated.

(1) Since the friction welding process is used, portions of metal related to the joining are firmly combined over an entire contacting surface of the joined portion 9. Therefore, unlike the plastic combination etc., since magnetic resistance at the joint portion can be reduced, performance of the electromagnetic clutch is improved.
(2) Since the magnetic annular member forming the outer ring portion 8 is not required of rigidity and may have the minimum thickness which satisfies a required magnetic performance, it is possible to reduce a weight.
(3) Since the outer ring portion 8 may be configured by an annular shape, e.g., a circular cylinder, it can be cheap.
(4) Since the metal each other firmly joined by the friction welding process, it is possible to achieve strength in a similar level in a case of forming integrally.
(5) In a case that material that demonstrates high magnetic performance is selected as material for the magnetic annular member which forms the outer ring portion 8, since metal each other joined firmly, even if there is a difference of coefficient of linear expansion between the outer ring portion 8 and the friction portion 7 which are joined, there is almost no effect on the strength.
(6) Since the friction welding process is a joining process by a simple contacting, it is possible to reduce steps related to the joining, and to suppress a weight increase as compared with a plastic joining etc.
(7) Since it can be performed to eliminate heat generation on a portion other than the joining surface, it is possible to provide a high accuracy of size and to improve a yield ratio.
(8) Since control factors of the friction welding process are mechanically set on a facility side, it is possible to suppress variation in joining quality, and to stabilize the magnetic performance.

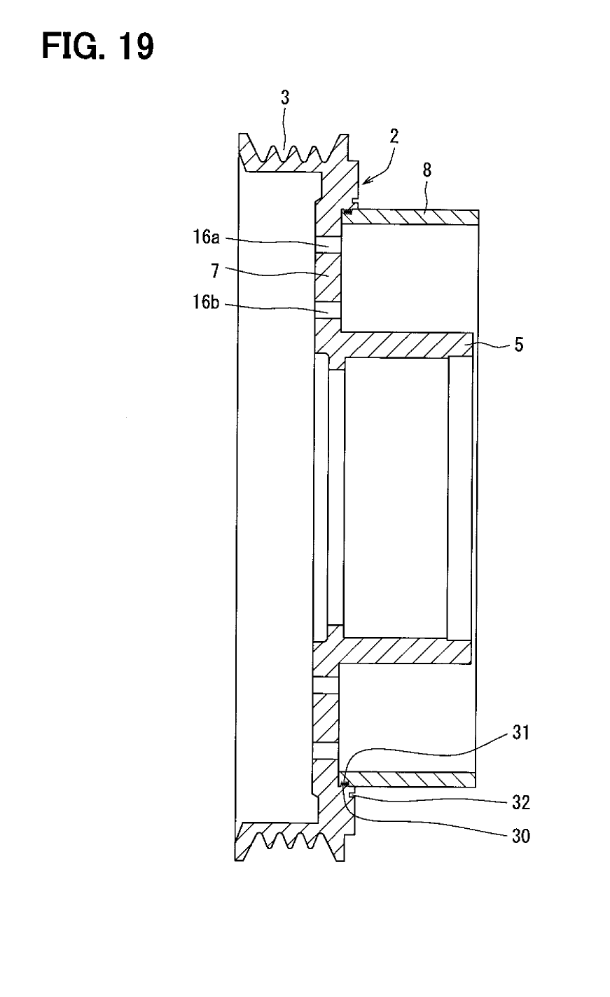

In a comparative example shown in FIG. 19, the magnetic flux generated by the electromagnetic coil follows the inside of the outer ring portion 8 in an axial direction which is a horizontal direction of FIG. 19, and it flows in the radial direction towards the stepped portion 30 from a side of the plurality of lines of grooves 31. Accordingly, as a magnetic path length becomes long, the magnetic resistance in the plastically joining portion between the grooves 31 and the stepped portion 30 becomes larger than the joined portion formed by the friction welding process.

In this point, in the first embodiment, a magnetic flux path which extends inside of the outer ring portion 8 in the axial direction, and enters into the friction portion 7 as it is in the axial direction is formed, and the joined portion 9 shows low magnetic resistance. In the first embodiment, at least, a magnetic member including the inner ring portion 5 and the friction portion 7, and the magnetic annular member including the outer ring portion 8 may be formed by the surface treated iron plate.

At least, the magnetic member including the inner ring portion 5 and the friction portion 7, and the magnetic annular member including the outer ring portion 8 are required a corrosion resistance property. The methods of the rust prevention treatment for acquiring corrosion resistance mainly involve a painting process. However, in the conventional technique, in order to make a paint layer not to be a large magnetic resistance, it is necessary to paint a magnetic member including the inner ring portion 5 and the friction portion 7 after combining them by a method such as the plastically combining method. On the other hand, by forming with the surface treated iron plate as mentioned above, impurities, such as a surface treated layer in the joined portion 9, are removed at the time of the friction welding process. Therefore, it is possible to use the surface treated iron plate by using that the impurity can be removed. Since the surface treated layer of the surface treated iron plate is removed at the time of the friction welding process, it does not increase magnetic resistance. In addition, since the surface treated iron plate has a rust prevention effect on the member itself, it is possible to eliminate a process of rust prevention treatment, such as a painting process.

### Function and Effect of the First Embodiment

In this first embodiment, the electromagnetic clutch 1 transmits rotational power from one side member to the other side member by an electromagnetic force, and has the inner ring portion 5 for holding the bearing 4 on an inner surface thereof and the friction portion 7 having the friction surface 6 extending in the radial direction from the inner ring portion 5. And it has the outer ring portion 8 which is formed in a cylindrical shape, and is joined to the friction portion 7, and is arranged to cover a periphery of the inner ring portion 5, and the pulley portion 3 which is formed integrally with the friction portion 7 or the outer ring portion 8 and provides the one side member. In addition, it has the electromagnetic coil 12 which is arranged between an outer surface of the inner ring portion 5 and the inner surface of the outer ring portion 8, and the armature 13 which is attracted to the friction portion 7 by the electromagnetic force generated by the electromagnetic coil 12 and provides the other side member. Further, it has the joined portion 9 which is joined between the outer ring portion 8 and the friction portion 7 by the friction welding process.

According to this, since it has the joined portion 9 which is joined by the friction welding process between the outer ring portion 8 and the friction portion 7, the outer ring portion 8 and the friction portion 7 are joined firmly at all over the joined portion 9 and between metal members. Accordingly, it is possible to achieve a magnetic property that is similar to a case of integrally forming the outer ring portion 8 and the friction portion 7. That is, magnetic flux generated by the electromagnetic coil 12 flows into the friction portion 7 from the outer ring portion 8 in a less magnetic resistance condition. Thereby, it can increase an attracting force by a small configuration, and can improve performance of the electromagnetic clutch 1. In addition, it can suppress a weight increase, and it can be less restriction about the degree of freedom of the member selection by considering a difference of coefficients of linear expansion. In addition, for the above part, it can suppress a weight increase.

The electromagnetic clutch 1 has the burr 22 formed by the friction welding process on the outside and the inside of the joined portion 9. Therefore, since the impurity of the friction welding surface is removed by being contained in the burr 22 etc., it is possible to reduce magnetic resistance of the magnetic flux flowing through the joined portion 9. In addition, since the burr 22 formed by the friction welding process is strong, there is no problem even if it left on the product.

The electromagnetic clutch 1 forms the ring shaped projection 21 on the side of the friction portion 7, and forms the joined portion 9 in a ring shape along the projection 21 by the friction welding process while contacting the outer ring portion 8 onto the projection 21. Therefore, it is possible to perform the friction welding process easily by concentrating generated heat to the projection by performing the friction welding process while contacting the outer ring portion 8 onto the projection 21.

The electromagnetic clutch 1 has an integrated configuration of the pulley portion 3, the inner ring portion 5, and the friction portion 7. In other words, at least the inner ring portion 5 and the friction portion 7 are configured by the integrally formed member 5 and 7 which is integrally formed by the magnetic member. A magnetic annular member which configures the outer ring portion 8 at least is firmly attached to the integrally formed member 5 and 7 by the joined portion 9.

According to this, at least the inner ring portion 5 and the friction portion 7 are configured by the integrally formed member 5 and 7 which is integrally formed by the magnetic member, and at least the outer ring portion 8 is configured by a magnetic annular member. Accordingly, it is possible to apply a relative rotational difference and the thrust to be a pressing force between two members, i.e., between the integrally formed member 5 and 7 and the outer ring portion 8. It is possible to perform a joining process by the friction welding process easily by generating friction heat at the joined portion 9 located between two members.

The stator 11, the electromagnetic coil 12, and the bobbin 15 provide a stator in the electromagnetic clutch 1. The armature 13 provides a movable member in the electromagnetic clutch 1. The stator forms and defines a clearance 9g which can accommodate the burr 22 in order to avoid collision of the burr 22 and the stator. The clearance 9g is provided by a chamfer formed on a corner portion of the stator 11. This chamfer is formed to face a corner portion next to the joined portion 9 of the friction portion 7 and the outer ring portion 8. The chamfer is formed larger than the other chamfers formed on the stator 11 in order to make it to accommodate the burr 22 which has unstable shapes.

### Second Embodiment

Next, a second embodiment of the invention is explained. In subsequent embodiments, a component that is the same as that in the first embodiment mentioned above is shown by the same reference symbol and is not explained, and and different component is explained. Subsequent to the second embodiment, the same reference symbols as the first embodiment shows the same component and the previous description shall be referenced.

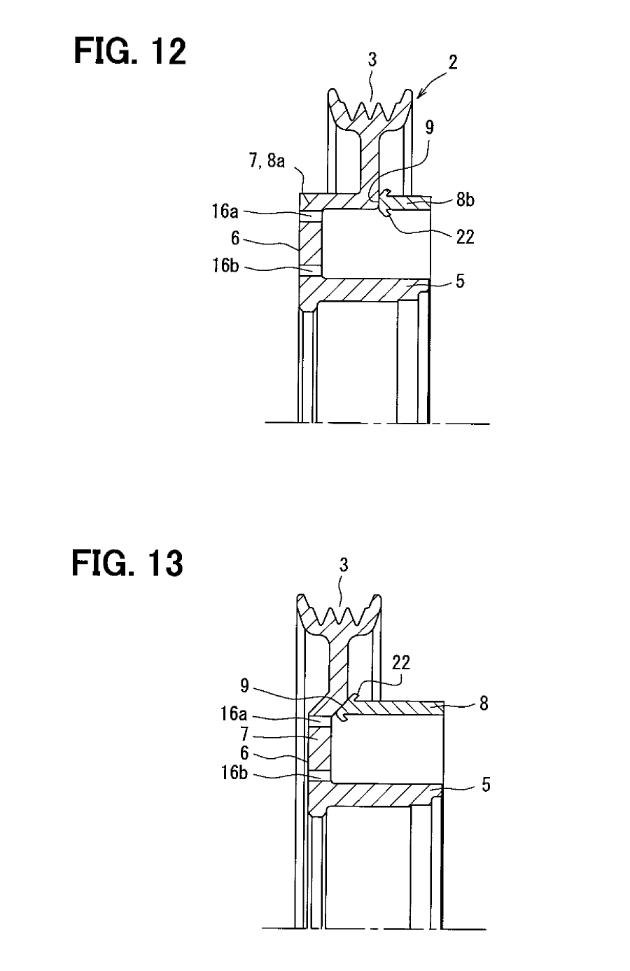

FIG. 12 shows a rotor 2 which is a part of the electromagnetic clutch according to the second embodiment of the invention. In this second embodiment, the inner ring portion 5 for holding a bearing, the friction portion 7 having the friction surface 6 against the armature, and the pulley portion 3 where a belt is applied are formed as an integrally formed member 3, 5, and 7, also called the integrally formed member 5 and 7, by a rolling process.

It has a configuration in which a part of the integrally formed member 5 and 7 becomes the first outer ring portion 8a which covers the electromagnetic coil. That is, the first outer ring portion 8a among the outer ring portion 8 (8a, 8b) is provided by an axial direction extending portion of the friction portion 7 which goes to the pulley portion 3. In addition, the second outer ring portion 8b is formed by a cylindrical portion 8b which is short and is in a ring shape.

The joined portion 9 made by the friction welding process is formed between the first outer ring portion 8a formed as a single member with the friction portion 7 and the second outer ring portion 8b. It is possible to receive the thrust on the second outer ring portion 8b at the time of the friction welding process by the first outer ring portion 8a which is formed as the single member with the friction portion 7 extending in the axial direction. In this case, relative rotational difference can be generated by fixing the side of the first outer ring portion 8a, and by rotating the side of the second outer ring portion 8b.

### Function and Effect of the Second Embodiment

In this second embodiment, the electromagnetic clutch, similar to the first embodiment, transmits rotational power from one side member to the other side member by an electromagnetic force, and has the inner ring portion 5 for holding the bearing 4 on an inner surface thereof and the friction portion 7 having the friction surface 6 extending in the radial direction from the inner ring portion 5. And it has the outer ring portion 8 which is formed in a cylindrical shape, and is joined to the friction portion 7, and is arranged to cover a periphery of the inner ring portion 5, and the pulley portion 3 which is formed integrally with the friction portion 7 and provides the one side member. The outer ring portion 8 corresponds to the second outer ring portion 8b.

In addition, it has the electromagnetic coil 12, it is not illustrated in FIG. 12, which is arranged between an outer surface of the inner ring portion 5 and the inner surface of the outer ring portion 8, and the armature 13 which is attracted to the friction portion 7 by the electromagnetic force generated by the electromagnetic coil 12 and provides the other side member.

In addition, it has the joined portion 9 joined by the friction welding process between the outer ring portion 8, i.e., the second outer ring portion 8b, and the friction portion 7, i.e., the friction portion 7 formed as the single member with the first outer ring portion 8a. In particular, the outer ring portion 8 is formed by the first outer ring portion 8a formed as the single member with the friction portion 7 and the second outer ring portion 8b in a separated manner, and it has the joined portion 9 joined by the friction welding process between the second outer ring portion 8b and the first outer ring portion 8a formed as the single member with the friction portion 7.

According to this, since it has the joined portion 9 which is joined by the friction welding process between the outer ring portion 8 and the friction portion 7, the outer ring portion 8 and the friction portion 7 are joined firmly at all over the joined portion 9 and between metal members. Accordingly, it is possible to achieve a magnetic property that is similar to a case of integrally forming the outer ring portion 8 and the friction portion 7. That is, magnetic flux generated by the electromagnetic coil 12 flows into the friction portion 7 from the outer ring portion 8 in a less magnetic resistance condition. Thereby, it can increase an attracting force by a small configuration, and can improve performance of the electromagnetic clutch 1. In addition, it can suppress a weight increase, and it can be less restriction about the degree of freedom of the member selection by considering a difference of coefficients of linear expansion. In addition, for the above part, it can suppress a weight increase.

Also in the second embodiment, similar to the first embodiment, a ring shaped projection 21, similar to FIG. 6, may be formed on a side of the friction portion 7 which is integral with the first outer ring portion 8a. The ring shaped joined portion 9 may be formed along the ring shaped projection 21 by the friction welding process while contacting the second outer ring portion 8b onto the projection 21. Thus, it is possible to perform the friction welding process easily by concentrating generated heat to the projection by performing the friction welding process while contacting the outer ring portion 8 onto the projection 21.

Next, in the second embodiment, the pulley portion 3, the inner ring portion 5, and the friction portion 7 are integrally formed. In other words, at least the inner ring portion 5 and the friction portion 7 are configured by the integrally formed member 5 and 7 which is integrally formed by the magnetic member. A magnetic annular member, a second outer ring portion 8b, which configures the outer ring portion 8 at least is firmly attached to the integrally formed member 5 and 7 by the joined portion 9.

Accordingly, it is possible to apply a relative rotational difference and the thrust to be a pressing force between two members, i.e., between the integrally formed member 5 and 7 and the second outer ring portion 8. It is possible to perform a joining process by the friction welding process easily by generating friction heat at the joined portion 9 located between two members.

### Third Embodiment

Next, a third embodiment of the invention is explained. Different parts from the above mentioned embodiments are explained. FIG. 13 shows a part of the electromagnetic clutch according to the third embodiment of the invention. The third embodiment has a configuration in which a joining surface for the friction welding process is formed in a tapered surface, as shown in FIG. 13. Since the joining surface for the friction welding process is formed in a tapered surface, it is possible to enlarge a surface area of the joined portion 9.

### Function and Effect of the Third Embodiment

In this third embodiment, the electromagnetic clutch, similar to the first embodiment, transmits rotational power from one side member to the other side member by an electromagnetic force, and has the inner ring portion 5 for holding the bearing 4 on an inner surface thereof and the friction portion 7 having the friction surface 6 extending in the radial direction from the inner ring portion 5. And it has the outer ring portion 8 which is formed in a cylindrical shape, and is joined to the friction portion 7, and is arranged to cover a periphery of the inner ring portion 5, and the pulley portion 3 which is formed integrally with the friction portion 7 or the outer ring portion 8 and provides the one side member.

In addition, it has the electromagnetic coil 12, it is not illustrated in FIG. 13, which is arranged between an outer surface of the inner ring portion 5 and the inner surface of the outer ring portion 8, and the armature 13 which is attracted to the friction portion 7 by the electromagnetic force generated by the electromagnetic coil 12 and provides the other side member. Further, it has the joined portion 9 which is joined between the outer ring portion 8 and the friction portion 7 by the friction welding process. Especially, it has the joined portion 9 joined by the friction welding process between the outer ring portion 8 and an inclined surface of the friction portion 7.

According to this, since it has the joined portion 9 which is joined by the friction welding process between the outer ring portion 8 and the friction portion 7, the outer ring portion 8 and the friction portion 7 are joined firmly at all over the joined portion 9 and between metal members. Accordingly, it is possible to achieve a magnetic property that is similar to a case of integrally forming the outer ring portion 8 and the friction portion 7. That is, magnetic flux generated by the electromagnetic coil 12 flows into the friction portion 7 from the outer ring portion 8 in a less magnetic resistance condition. Thereby, it can increase an attracting force by a small configuration, and can improve performance of the electromagnetic clutch 1. In addition, it can suppress a weight increase, and it can be less restriction about the degree of freedom of the member selection by considering a difference of coefficients of linear expansion. In addition, for the above part, it can suppress a weight increase.

Also in the third embodiment, similar to the first embodiment, a ring shaped projection 21 may be formed on a part of an inclined surface of the friction portion 7. The ring shaped joined portion 9 may be formed along the inclined ring shaped projection 21 by performing the friction welding process while contacting the outer ring portion 8 onto the projection 21. Thus, it is possible to perform the friction welding process easily by concentrating generated heat to the projection by performing the friction welding process while contacting the outer ring portion 8 onto the projection 21.

Next, in the third embodiment, the pulley portion 3, the inner ring portion 5, and the friction portion 7 are integrally formed. In other words, at least the inner ring portion 5 and the friction portion 7 are configured by the integrally formed member 5 and 7 which is integrally formed by the magnetic member. A magnetic annular member which configures the outer ring portion 8 at least is firmly attached to the integrally formed member 5 and 7 by the joined portion 9.

Accordingly, it is possible to apply a relative rotational difference and the thrust to be a pressing force between two members, i.e., between the integrally formed member 5 and 7 and the outer ring portion 8. It is possible to perform a joining process by the friction welding process easily by generating friction heat at the joined portion 9 located between two members.

### Fourth Embodiment

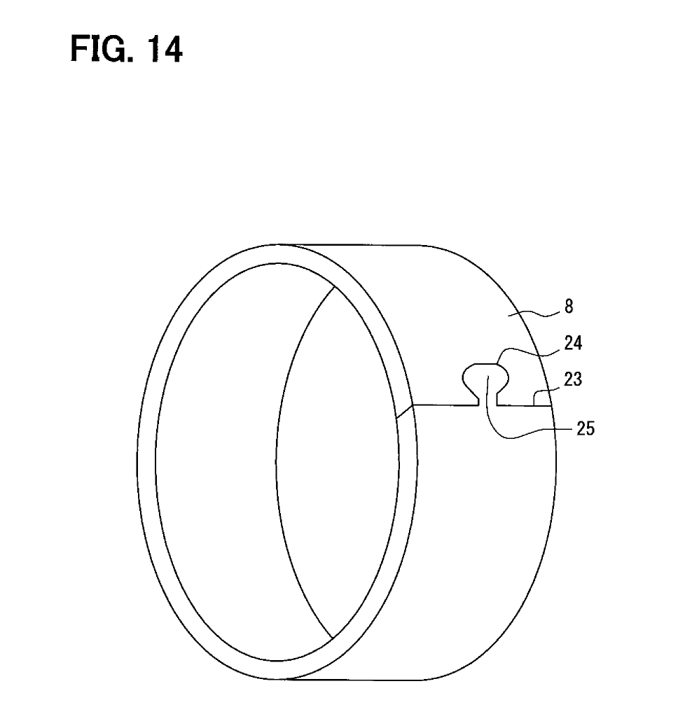

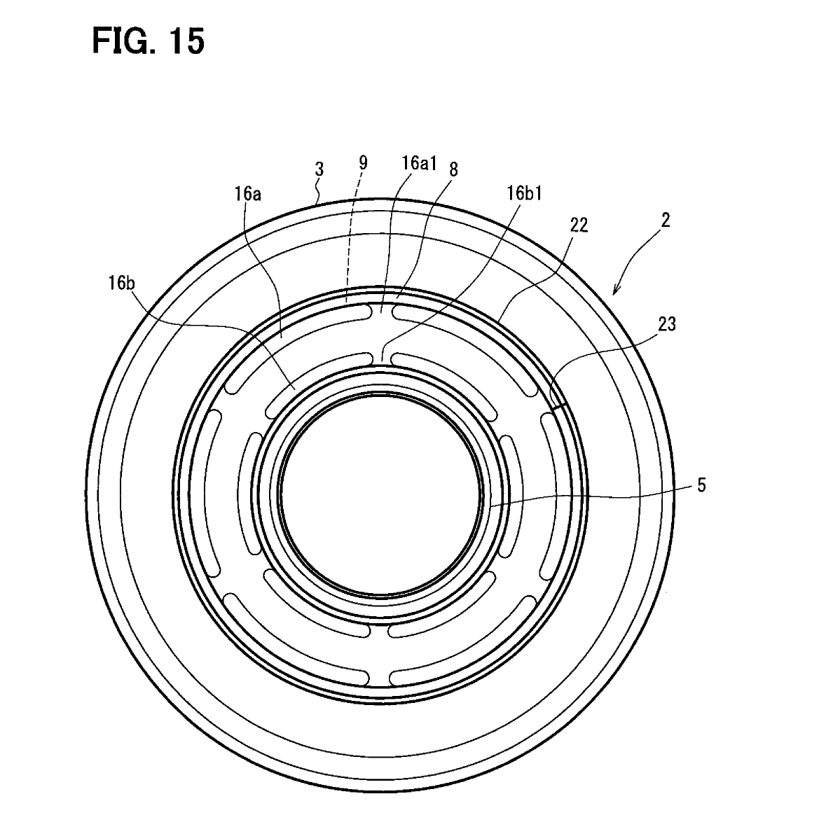

Next, a fourth embodiment of the invention is explained. Different parts from the above mentioned embodiments are explained. FIG. 14 shows a metal ring which forms an outer ring portion 8 for an electromagnetic clutch according to a fourth embodiment of the invention. FIG. 15 shows a rotor of the electromagnetic clutch of the fourth embodiment by viewing from the arrow symbol III similar to FIG. 3.

In FIG. 14, the outer ring portion 8 is configured by using a member which is formed by forming a belt shaped member into a ring having a C-shape in cross section and by joining, not using a continuous annular member. Since the belt shaped member is rounded and joined, there is a break 23. In this configuration, since the rigidity of the outer ring portion 8 improves, it is desirable that members each other are formed in meshing shapes as shown in FIG. 14, such as a recessed portion 24 and a projected portion 25, at a forming process.

In a case of the continuous annular member, it is necessary to cut and form a pipe member, according to the structure of FIG. 14, it is possible to configure the outer ring portion 8 by processing the belt shaped member into a round shape. The belt shaped member may be cheaper than the continuous annular member, even including the forming cost, it is possible to cut the cost.

Also in FIG. 15, there is one break 23 on the outer ring portion 8 which configured by using a member which is formed by forming and joining the belt shaped member into a ring having a C-shape in cross section. Since magnetic flux flow is perpendicular to the paper surface FIG. 15, there is less possibility of lowering of performance caused by the break.

### Function and Effect of the Fourth Embodiment

In the fourth embodiment, the outer ring portion 8 is formed by a C-shape member, in cross-section, which is formed by rounding and joining annularly a belt shaped member. According to this, it is possible to manufacture the outer ring portion 8 having arbitrary outside diameters easily, compared with a case of forming the outer ring portion by cutting a pipe member.

### Fifth Embodiment

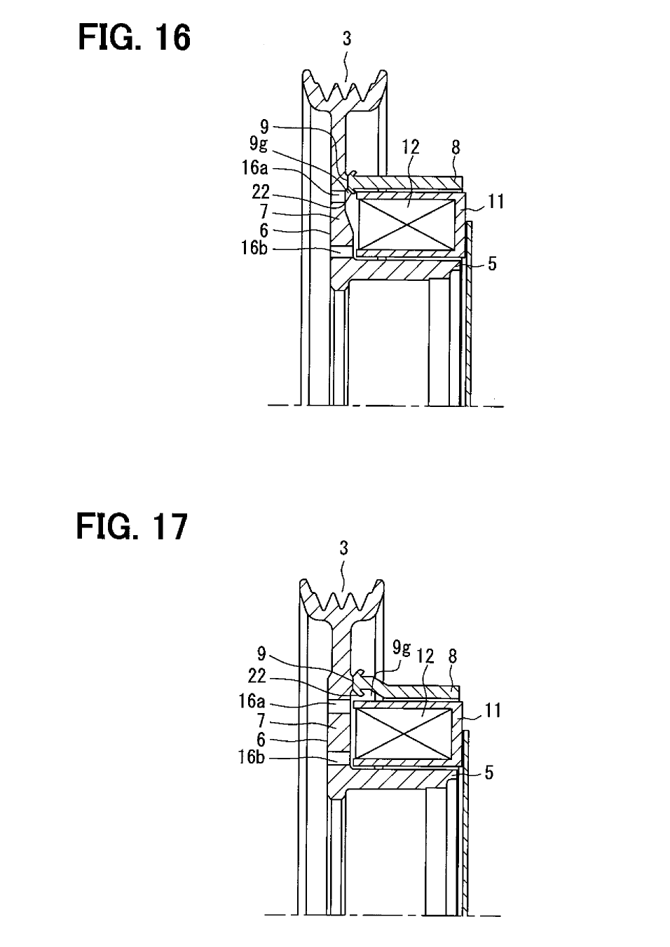

Next, a fifth embodiment of the invention is explained. Different parts from the above mentioned embodiments are explained. FIG. 16 shows a part of the electromagnetic clutch according to the fifth embodiment of the invention. The fifth embodiment has a configuration of a rotor which enables to eliminate a process for removing burr 22 by arranging the burr 22 in the friction welding process on a portion which does not affect arrangement of the stator 11.

In order to achieve it, as shown in FIG. 16, it uses a configuration in which a thickness of the friction portion 7 is formed thinner at a stage reaching to the outer ring portion 8 from the inner ring portion 5, and a space which extends in an axial direction and accommodates the burr 22 is formed within a thickness difference thereof. Thereby, it is possible to eliminate a process of removing the burr 22 after the friction welding process.

### Function and Effect of the Fifth Embodiment

In the fifth embodiment, in order to avoid collision of the burr 22 and the stator, the axially extending clearance 9g for accommodating burr 22 is formed on a portion of the outer ring portion 8 next to the burr 22. The clearance 9g is provided by forming the friction portion 7 so that a distance in the axial direction between the friction portion 7 and the stator is enlarged. According to this, since the clearance 9g which is sufficient is formed between the burr 22 and the electromagnetic coil 12, it is possible to avoid a trouble, such as that it is hard to put the electromagnetic coil 12 in a proper position between the outer ring portion 8 and the inner ring portion 5 due to a collision of the burr 22 onto the electromagnetic coil 12.

### Sixth Embodiment

Next, a sixth embodiment of the invention is explained. Different parts from the above mentioned embodiments are explained. FIG. 17 shows a partial vertical cross sectional view of the electromagnetic clutch according to the sixth embodiment of the invention. The sixth embodiment has a configuration which securely forms the clearance 9g for escaping burr 22 in the radial direction by expanding outwardly a part of a diameter of the side to the joined portion 9 in the outer ring portion 8. Thereby, it is possible to eliminate a process of removing the burr 22 after the friction welding process.

### Function and Effect of the Sixth Embodiment

In the sixth embodiment, a part on the outer ring portion 8 next to the burr 22 expands outwardly in a radial direction in order to avoid collision of the burr 22 and the stator. The clearance 9g is provided by forming the outer ring portion 8 so that a distance in the radial direction between the joined portion 9 and the stator is enlarged. According to this, since the radial clearance 9g which is sufficient is formed between the burr 22 and the electromagnetic coil 12, it is possible to avoid a trouble, such as that it is hard to put the electromagnetic coil 12 in a proper position between the outer ring portion 8 and the inner ring portion 5 due to a collision of the burr 22 onto the electromagnetic coil 12.

### Seventh Embodiment

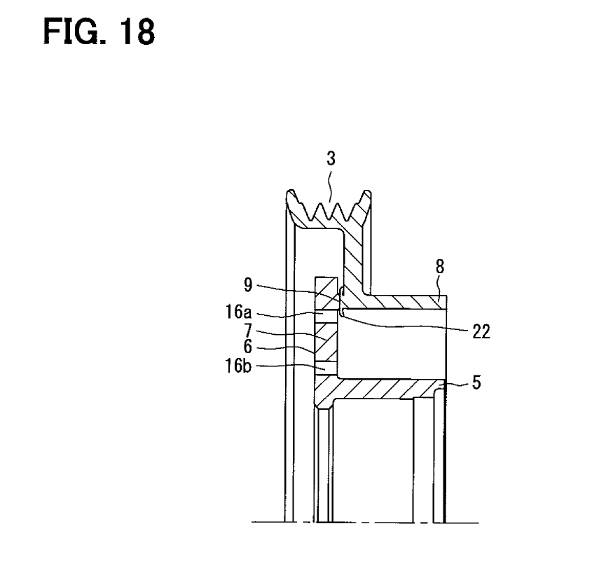

Next, a seventh embodiment of the invention is explained. Different parts from the above mentioned embodiments are explained. FIG. 18 shows a partial vertical cross sectional view of the electromagnetic clutch according to the seventh embodiment of the invention. In this seventh embodiment, the inner ring portion 5 and the friction portion 7 are formed integrally as a magnetic member. In addition, it is a rotor configuration in which the outer ring portion 8 and the pulley portion 3 are provided by an integrally formed magnetic annular member, and both are combined at the joined portion 9 by the friction welding process.

In this seventh embodiment, the friction welding process is performed by fixing a side of the inner ring portion 5, and rotating the outer ring portion 8 which is integrated with the pulley portion 3 by a friction welding process machine. Of course, it is also possible to perform the friction welding process by rotating the side of the inner ring portion 5 conversely, and fixing the outer ring portion 8 integrally formed with the pulley portion 3.

### Function and Effect of the Seventh Embodiment

In this seventh embodiment, the electromagnetic clutch, similar to the first embodiment, transmits rotational power from one side member to the other side member by an electromagnetic force, and has the inner ring portion 5 for holding the bearing 4 on an inner surface thereof and the friction portion 7 having the friction surface 6 extending in the radial direction from the inner ring portion 5. And it has the outer ring portion 8 which is formed in a cylindrical shape, and is joined to the friction portion 7, and is arranged to cover a periphery of the inner ring portion 5, and the pulley portion 3 which is formed integrally with the friction portion 7 or the outer ring portion 8 and provides the one side member.

In addition, it has the electromagnetic coil 12, similar to FIG. 1, which is arranged between an outer surface of the inner ring portion 5 and the inner surface of the outer ring portion 8, and the armature 13 which is attracted to the friction portion 7 by the electromagnetic force generated by the electromagnetic coil 12 and provides the other side member. Further, it has the joined portion 9 which is joined between the outer ring portion 8 and the friction portion 7 by the friction welding process. In particular, the outer ring portion 8 and the pulley portion 3 are formed as a single member, the friction portion 7 and the inner ring portion 5 are formed as a single member, and it has the joined portion 9 joined by the friction welding process between the friction portion 7 and the outer ring portion 8.

According to this, since it has the joined portion 9 which is joined by the friction welding process between the outer ring portion 8 and the friction portion 7, the outer ring portion 8 and the friction portion 7 are joined firmly at all over the joined portion 9 and between metal members. Accordingly, it is possible to achieve a magnetic property that is similar to a case of integrally forming the outer ring portion 8 and the friction portion 7. That is, magnetic flux generated by the electromagnetic coil 12 flows into the friction portion 7 from the outer ring portion 8 in a less magnetic resistance condition. Thereby, it can increase an attracting force by a small configuration, and can improve performance of the electromagnetic clutch 1. In addition, it can suppress a weight increase, and it can be less restriction about the degree of freedom of the member selection by considering a difference of coefficients of linear expansion. In addition, for the above part, it can suppress a weight increase.

Also in the seventh embodiment, similar to the first embodiment, a ring shaped projection 21, similar to FIG. 6, may be formed on a side of the friction portion 7. The joined portion 9 may be formed along the projection 21 by performing the friction welding process while contacting the second outer ring portion 8b onto the projection 21. Thus, it is possible to perform the friction welding process easily by concentrating generated heat to the projection by performing the friction welding process while contacting the outer ring portion 8 onto the projection 21.

Next, in the seventh embodiment, the pulley portion 3 and the outer ring portion 8 are integrally formed, and the inner ring portion 5 and the friction portion 7 are integrally formed. In other words, at least the inner ring portion 5 and the friction portion 7 are configured by the integrally formed member 5 and 7 which is integrally formed by the magnetic member. A magnetic annular member which configures the outer ring portion 8 at least is firmly attached to the integrally formed member 5 and 7 by the joined portion 9.

Accordingly, it is possible to apply a relative rotational difference and the thrust to be a pressing force between two members, i.e., between the integrally formed member 5 and 7 and the outer ring portion 8. It is possible to perform a joining process by the friction welding process easily by generating friction heat at the joined portion 9 located between two members.

### Other Embodiments

Although preferred embodiments are described in the above mentioned embodiments, the present invention is not limited to the above embodiments, and the above embodiments may be modified in various ways without departing from the spirit and scope of the invention. The configuration of the above described embodiments is just examples. The invention in its broader terms is therefore not limited to the specific details, representative apparatus, and illustrative examples shown and described. Some extent of the disclosure may be shown by the scope of claim, and also includes the changes, which is equal to and within the same range of the scope of claim.

Although the air in the arc shaped hole or the slit is shown as an example of a nonmagnetic material, the other nonmagnetic metal, such as copper and aluminum, and the nonmagnetic resin in accordance with an application may be used.

Although the electromagnetic clutch used for the compressor which compresses the refrigerant is shown as an example in the preceding embodiments, the invention may be applied to any electromagnetic clutch, which is used within vehicles, which perform a power connection and disconnection, such as for a supercharger and an automatic transmission, or an electromagnetic clutch for general purpose machines.

Furthermore, for example, in FIG. 2, the integrally formed member including the inner ring portion 5 and the friction portion 7, and the magnetic annular member including the outer ring portion 8 may be formed by a surface treated iron plate. The rotor for the electromagnetic clutch shown in FIG. 2 is required to have anti-corrosion property. A typical rust prevention treatment for this purpose is painting.

However, in the conventional technique, in order to make a paint layer not to be a large magnetic resistance, it is necessary to perform a painting process after combining the outer ring to the integrally formed member by a method such as the plastically combining method. On the other hand, in the above-mentioned structure using the surface treated iron plate, impurities, such as the surface treatment layer, of the joined portion 9 are removed as the burr 22 etc., at the time of the friction welding process.

Therefore, it is possible to adopt the surface treated iron plate as the member for configuring the rotor by using the above. Since the surface treatment layer is removed as the burr 22 etc., at the time of pressurized contacting process, it does not cause an increase in magnetic resistance. Since the surface treated iron plate has a rust prevention effect on the member itself, it is possible to eliminate a process of rust prevention, such as painting process. This may be raised as an advantageous function and effect.

In addition, heating in the friction welding process and subsequent cooling may be performed in a vacuum or an inactive gas, e.g., nitrogen gas, atmosphere.

Furthermore, the friction welding process may be performed while heating a portion to be friction welded in a low frequency induction heating manner by applying alternating magnetic field.

In addition, in FIG. 6, the friction welding process is performed after piercing the arcuate holes 16a and 16b by a pressing process, however, the arcuate holes 16a and 16b may be pierced by a pressing process after performing the friction welding process previously. In this case, since the friction welding process is performed during condition with no arcuate holes 16a and 16b, since a high thermal energy generated at the time of the friction welding process can be dissipated uniformly, it is hard to create a local thermal strain.

In the above-mentioned embodiment, although the burr generated by the friction welding process is kept on a product, it may be removed by cutting process etc. Especially, the burr on the side where a collision may occur, may be removed.

Furthermore, taking a condition of dissipation of frictional heat generated at the time of friction welding process into consideration, it is necessary to consider a heat balance during the friction welding process in order to avoid a high temperature on a specific part. In order to adjust the heat balance, adjusting a thickness, or forming a groove or a hole may be performed on a heat conducting member as long as strength permits. In other words, it is necessary to adjust a heat generating condition of each portion while taking a heat dissipation way during the friction welding process into consideration. For example, it is necessary to avoid that a one material melts due to excessive high temperature.

In the above-mentioned embodiments, although the projection 21, see FIG. 6, in a ring shape of about 1 mm is disposed in the above-mentioned embodiments, the projection 21 is not an essential element. On the contrary, a collision of the burr and the electromagnetic coil may be avoided by forming a depression in a ring shape and by performing the friction welding process within the depression and performing the process to accommodate the burr in the depression.

1. An electromagnetic clutch for transmitting rotational force from a one side member to the other side member by using electromagnetic force, comprising:
an inner ring portion which is formed in a cylindrical shape and holds a bearing on an inner surface thereof;
a friction portion which has a friction surface extending in a radial direction from the inner ring portion;
an outer ring portion which is formed in a cylindrical shape, arranged to cover an outer periphery of the inner ring portion, and is joined to the friction portion;
a pulley portion which provides the one side member and is formed integrally with the friction portion or the outer ring portion;
a stator including an electromagnetic coil arranged between an outer surface of the inner ring portion, and an inner surface of the outer ring portion; and
an armature which provides the other side member and is attracted to the friction portion by the electromagnetic force generated by the electromagnetic coil, and wherein
the outer ring portion is joined to the friction portion by a joined portion formed by a friction welding process.

2. The electromagnetic clutch in claim 1, wherein
at least the inner ring portion and the friction portion are configured by an integrally formed member which is integrally formed by the magnetic member, and
at least a magnetic annular member forming the outer ring portion is joined to the integrally formed member via the joined portion.

3. The electromagnetic clutch in claim 1, wherein
the friction portion is formed with a projection in a ring shape, and t the joined portion is formed by the friction welding process while contacting the outer ring portion onto the projection and extends in a ring shape along the projection.

4. The electromagnetic clutch in claim 1, further comprising
a burr formed on an inside and an outside of the joined portion by the friction welding process.

5. The electromagnetic clutch in claim 4, further comprising
a clearance for accommodating the burr, which is formed on a portion next to the electromagnetic coil, and which extends in an axial direction or a radial direction, in order to avoid collision of the burr and the stator.

6. The electromagnetic clutch in claim 5, wherein
a part of the outer ring portion next to the burr is expanded in a radial direction to form the clearance.

7. The electromagnetic clutch in claim 5, wherein
the clearance is formed between the friction portion and the stator.

8. The electromagnetic clutch in claim 1, wherein
a magnetic member including the inner ring portion and the friction portion, and a magnetic annular member including the outer ring portion, at least, are formed by a surface treated iron plate.

9. The electromagnetic clutch in claim 1, wherein
the outer ring portion is formed by a C-shape member, in cross-section, which is formed by rounding and joining annularly a belt shaped member.
